(19) United States
(12) Patent Application Publication
(10) Pub. No.: US 2008/0056146 A1
(43) Pub. Date: Mar. 6, 2008

(54) METHOD AND APPARATUS FOR DETERMINING MAXIMUM ROUND TRIP TIMES FOR A NETWORK SOCKET

(76) Inventors: Steven L. Elliott, Austin, TX (US); Nikhil Gupta, Cedar Park, TX (US); Christopher Victor Lazzaro, Austin, TX (US)

Correspondence Address: IBM CORP (YA);C/O YEE & ASSOCIATES PC, P.O. BOX 802333, DALLAS, TX, 75380, US

(21) Appl. No.: 11/468,161

(22) Filed: Aug. 29, 2006

(51) Int. Cl. H04J 1/16

(52) U.S. Cl. 370/252

(57) ABSTRACT

A computer implemented method, apparatus, and computer usable program code for identifying a maximum round trip time over a socket for use in transmitting data over a connection. During a beginning phase of a send operation through a socket, packets are sent on the connection as fast as possible. The as fast as possible value is determined by the network and an event is generated that flows back to the application. Sending of the packets is halted in response to this event. Round trip times for the packets sent are identified by waiting for the acknowledgement for the packets sent. The maximum round trip time from the various round trip times is identified, wherein the maximum round trip time used in an adaptive bandwidth control algorithm to determine the optimum rate of sending the data to the endpoint.

### CROSS-REFERENCE TO RELATED APPLICATION

The present invention is related to the following application entitled Method and Apparatus for Determining Minimum Round Trip Times for a Network Socket, Elliott et al., Attorney Docket AUS920060706US1, Ser. No. ______; filed even date hereof, assigned to a common assignee, and which is incorporated herein by reference.

### BACKGROUND OF THE INVENTION

1. Field of the Invention

The present invention relates generally to an improved data processing system and in particular to a method and apparatus for processing data. Still more particularly, the present invention relates to a computer implemented method, apparatus, and computer usable program product for determining round trip times for a network socket.

2. Description of the Related Art

In transmitting data over the internet, the transmission control protocol (TCP) is one of the core protocols in which applications on network hosts can create connections to other applications. Data is exchanged in packets over these types of connections. In generating connections for TCP, the round trip time is an important part of different algorithms used to avoid congestion. Round trip time is the length of time from when a packet is sent until an acknowledgement of the packet is received. Currently, no reliable way is present to determine the minimum or maximum round trip time of any given socket connection. A socket is a communication endpoint that is unique to a particular data processing system communicating on an internet protocol based network, such as the Internet. A socket connection in which sockets are used at the endpoints between the applications exchanging data.

The maximum round trip time and the minimum round trip time are important when sending adaptive distributions. Most networks only have a limited amount of bandwidth available. Critical business network traffic fluctuates in the amount of bandwidth needed. Non-critical software distributions, can easily use all available network bandwidth and slow down critical business network traffic. Adaptive distributions are distributions that automatically adapt to network conditions in order to reduce impact on the network and thus to the critical business applications.

Adaptive distribution software uses adaptive bandwidth control algorithms that measure the entire network performance from the perspective of the two ends of a network socket connection including all routers in between. When the network is not being used, the adaptive distributions dynamically send the distribution at a fast rate of speed. If there is a network impedance, such as a backup, clog, or congestion between the two ends, the adaptive distribution dynamically slows down the transfer rate to allow for other network traffic to proceed unhindered. The maximum round trip time and the minimum round trip time are used by adaptive distribution.

### SUMMARY OF THE INVENTION

The present invention provides a computer implemented method, apparatus, and computer usable program code for identifying a maximum round trip time over a socket for use in transmitting data over a connection. During a beginning phase of a send operation through a socket, packets are sent on the connection as fast as possible. The as fast as possible value is determined by the network and an event is generated that flows back to the application. Sending of the packets is halted in response to this event. Round trip times for the packets sent are identified by waiting for the acknowledgement for the packets sent. The maximum round trip time from the various round trip times is identified, wherein the maximum round trip time used in an adaptive bandwidth control algorithm to determine the optimum rate of sending the data to the endpoint.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which illustrative embodiments may be implemented;

FIG. 2 depicts a block diagram of a data processing system in which illustrative embodiments may be implemented;

FIG. 3 is a diagram of a transmission control protocol/Internet protocol (TCP/IP) and similar protocols in accordance with a preferred embodiment of the present invention;

FIG. 4 is a flowchart of a process for determining a maximum round trip time in accordance with an illustrative embodiment; and

FIG. 5 is a flowchart of a process for determining a minimum round trip time in accordance with an illustrative embodiment.

### DETAILED DESCRIPTION OF THE PREFERRED EMBODIMENT

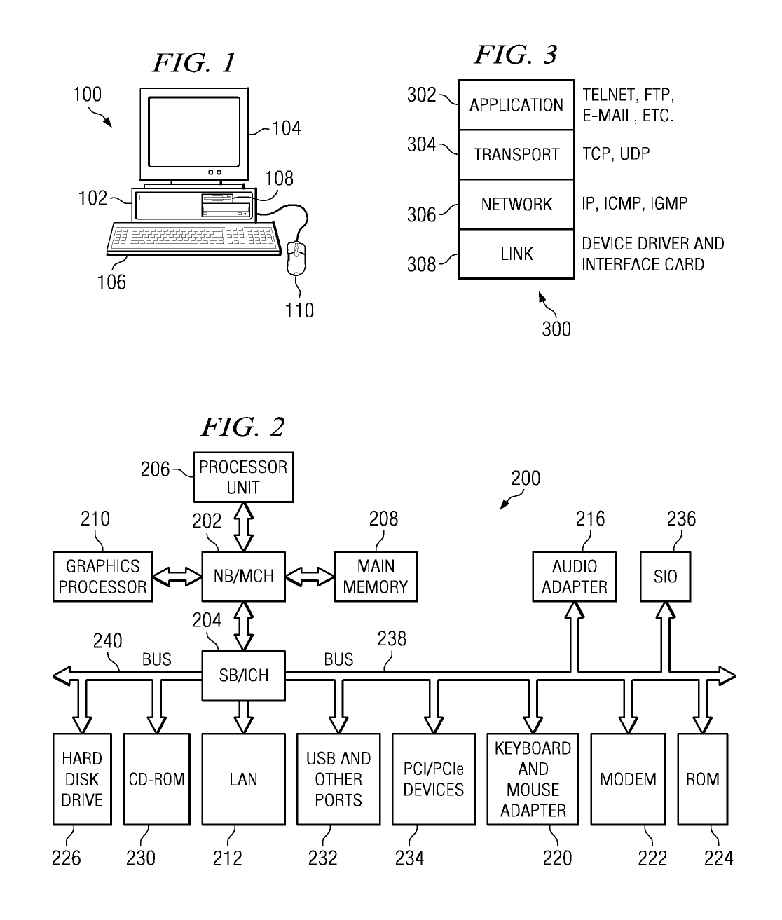

With reference now to the figures and in particular with reference to FIG. 1, a pictorial representation of a data processing system is shown in which illustrative embodiments may be implemented. Computer 100 includes system unit 102, video display terminal 104, keyboard 106, storage devices 108, which may include floppy drives and other types of permanent and removable storage media, and mouse 110. Additional input devices may be included with personal computer 100. Examples of additional input devices include a joystick, touchpad, touch screen, trackball, microphone, and the like.

Computer 100 may be any suitable computer, such as an IBM® eServer™ computer or IntelliStation® computer, which are products of International Business Machines Corporation, located in Armonk, N.Y. Although the depicted representation shows a personal computer, other embodiments may be implemented in other types of data processing systems. For example, other embodiments may be implemented in a network computer. Computer 100 also preferably includes a graphical user interface (GUI) that may be implemented by means of systems software residing in computer readable media in operation within computer 100.

Next, FIG. 2 depicts a block diagram of a data processing system in which illustrative embodiments may be implemented. Data processing system 200 is an example of a computer, such as computer 100 in FIG. 1, in which code or instructions implementing the processes of the illustrative embodiments may be located.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204, audio adapter 216, keyboard and mouse adapter 220, modem 222, read only memory (ROM) 224, universal serial bus (USB) ports, and other communications ports 232. PCI/PCIe devices 234 are coupled to south bridge and I/O controller hub 204 through bus 238. Hard disk drive (HDD) 226 and CD-ROM drive 230 are coupled to south bridge and I/O controller hub 204 through bus 240.

PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206. This operating system coordinates and controls various components within data processing system 200 in FIG. 2. The operating system may be a commercially available operating system, such as Microsoft® Windows XP®. (Microsoft® and Windows XP® are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java-based trademarks are trademarks of Sun Microsystems, Inc. in the United States, other countries, or both.

Instructions for the operating system, the object-oriented programming system, and applications or programs are located on storage devices, such as hard disk drive 226. These instructions and may be loaded into main memory 208 for execution by processor 206. The processes of the illustrative embodiments may be performed by processor 206 using computer implemented instructions, which may be located in a memory. An example of a memory is main memory 208, read only memory 224, or in one or more peripheral devices.

The hardware shown in FIG. 1 and FIG. 2 may vary depending on the implementation of the illustrated embodiments. Other internal hardware or peripheral devices, such as flash memory, equivalent non-volatile memory, or optical disk drives and the like, may be used in addition to or in place of the hardware depicted in FIG. 1 and FIG. 2. Additionally, the processes of the illustrative embodiments may be applied to a multiprocessor data processing system.

The systems and components shown in FIG. 2 can be varied from the illustrative examples shown. In some illustrative examples, data processing system 200 may be a personal digital assistant (PDA). A personal digital assistant generally is configured with flash memory to provide a non-volatile memory for storing operating system files and/or user-generated data. Additionally, data processing system 200 can be a tablet computer, laptop computer, or telephone device.

Other components shown in FIG. 2 can be varied from the illustrative examples shown. For example, a bus system may be comprised of one or more buses, such as a system bus, an I/O bus, and a PCI bus. Of course the bus system may be implemented using any suitable type of communications fabric or architecture that provides for a transfer of data between different components or devices attached to the fabric or architecture. Additionally, a communications unit may include one or more devices used to transmit and receive data, such as a modem or a network adapter. Further, a memory may be, for example, main memory 208 or a cache such as found in north bridge and memory controller hub 202. Also, a processing unit may include one or more processors or CPUs.

The depicted examples in FIG. 1 and FIG. 2 are not meant to imply architectural limitations. In addition, the illustrative embodiments provide for a computer implemented method, apparatus, and computer usable program code for compiling source code and for executing code. The methods described with respect to the depicted embodiments may be performed in a data processing system, such as data processing system 100 shown in FIG. 1 or data processing system 200 shown in FIG. 2.

FIG. 3 is a diagram of a transmission control protocol/Internet protocol (TCP/IP) and similar protocols is depicted in accordance with a preferred embodiment of the present invention. TCP/IP and similar protocols are utilized by communications architecture 300. In this example, communications architecture 300 is a 4-layer system. This architecture includes application layer 302, transport layer 304, network layer 306, and link layer 308. Each layer is responsible for handling various communications tasks. Link layer 308 also is referred to as the data-link layer or the network interface layer and normally includes the device driver in the operating system and the corresponding network interface card in the computer. This layer handles all the hardware details of physically interfacing with the network media being used, such as optical cables or Ethernet cables.

Network layer 306 also is referred to as the internet layer and handles the movement of packets of data around the network. For example, network layer 306 handles the routing of various packets of data that are transferred over the network. Network layer 306 in the TCP/IP suite is comprised of several protocols, including Internet protocol (IP), Internet control message protocol (ICMP), and Internet group management protocol (IGMP).

Next, transport layer 304 provides an interface between network layer 306 and application layer 302 that facilitates the transfer of data between two host computers. Transport layer 304 is concerned with things such as, for example, dividing the data passed to it from the application into appropriately sized chunks for the network layer below, acknowledging received packets, and setting timeouts to make certain the other end acknowledges packets that are sent. In the TCP/IP protocol suite, two distinctly different transport protocols are present, TCP and User datagram protocol (UDP). TCP provides reliability services to ensure that data is properly transmitted between two hosts, including dropout detection and retransmission services.

Conversely, UDP provides a much simpler service to the application layer by merely sending packets of data called datagrams from one host to the other, without providing any mechanism for guaranteeing that the data is properly transferred. When using UDP, the application layer must perform the reliability functionality.

Application layer 302 handles the details of the particular application. Many common TCP/IP applications are present for almost every implementation, including a Telnet for remote login; a file transfer protocol (FTP); a simple mail transfer protocol (SMTP) for electronic mail; and a simple network management protocol (SNMP). The mechanism of the present invention may be more specifically implemented in a layer, such as transport layer 304. For example, the different processes of the present invention may be implemented in application layer 302.

The illustrative embodiments provide a computer implemented method, apparatus, and computer usable program code for identifying round trip times. The illustrative embodiments may be employed to determining maximum and minimum round trip times. In the illustrative embodiments, at the beginning or during the send on a socket, the sender sends packets on the network as fast as possible. This send process is continued until a reliable value is determined for the maximum round trip time.

One advantage of this illustrative embodiment is that the maximum round trip time can be efficiently and reliably computed based on the real network conditions at the time of that the packets are sent. In the illustrative examples, a fast start mode can be configured to run at the beginning of the send phase for each endpoint.

During this mode, the sender sends as fast as possible on the network, until a condition for exiting this mode is met. Where the conditions for exiting the fast start mode are, for example, specified time period, stable round trip time measurements, a specified number of packets have been sent, or a specified amount of data has been sent. This mode may be ended after a period of time specified in seconds or after an indication is identified that no more data can be sent on this connection. In this disclosure, a TCP socket error, such as EWOULDBLOCK, is used. Using this type of error may reduce the amount of time spent in determining the maximum round trip time.

Using this type of implementation, the maximum round trip time involves sending application data packets on the network as fast as possible and monitoring when acknowledgements are received. The illustrative embodiments also may be used to calculate a minimum round trip time. The calculation of the minimum round trip time is calculated at the application layer level rather than at the TCP (transport) level in these examples.

In these examples, the minimum round trip time on a socket may be obtained without introducing congestion on the link. During a mode of operation for obtaining a minimum round trip time, two packets are sent on a connection and the process waits for acknowledgements to return. Once acknowledgements are received, another two packets are sent and the process again waits for the acknowledgements to return. This process is repeated for some predetermined period of time and the lowest value of the round trip time is used as the minimum round trip value.

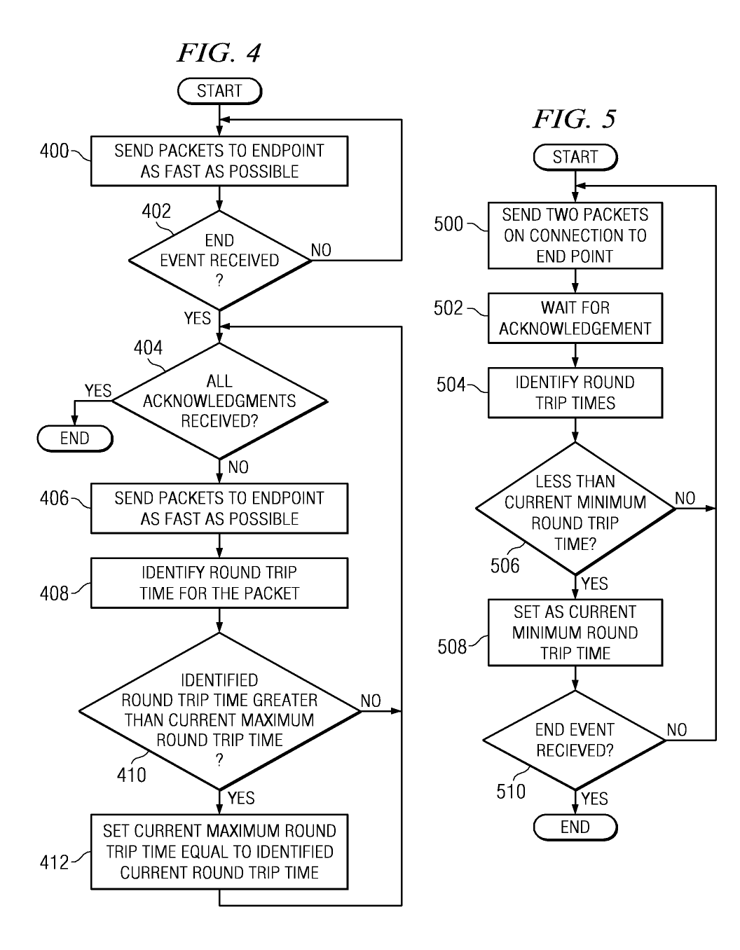

Turning now to FIG. 4, a flowchart of a process for determining a maximum round trip time is depicted in accordance with an illustrative embodiment. The process in this illustrative example may be performed in transport layer 304 in FIG. 3.

The process begins by sending packets to the endpoint as fast as possible (step 400). Next, a determination is made as to whether an end event is received (step 402). In these examples, the event may take various forms. For example, the event may be the elapse of a time period. For example, the time period may be five seconds and packets are sent on the network during these five seconds. When the five seconds have occurred, no more packets are sent and the highest round trip time for acknowledgements received for those packets are identified as the maximum round trip time. In another example, the event may be receiving an indication that the network has been congested. This event may be, the receipt of a EWOULDBLOCK message. Then, no additional packets are sent and the current maximum round trip time is the highest value for the packets that were sent before the indication was received.

Alternatively, the packets can be sent as fast as possible on the network until round trip time values that are received for acknowledgements become constant and do not increase.

If an end event has been received in step 402, the process further determines if all acknowledgements are received (step 404). If all acknowledgements are received in step 404, the process terminates.

If all acknowledgements have not been received in step 404, the process sends packets to endpoints as fast as possible (step 406).

Next, the process identifies round trip times for the packets for which an acknowledgement that has been received (step 408). A determination is then made as to whether the identified round trip time for this packet is greater than the current maximum round trip time (step 410). If the identified round trip time is greater than the current maximum round trip time in step 410, the process sets the current maximum round trip time equal to the identified current round trip time (step 412). Thereafter the process returns to step 404 to determine if all acknowledgements are received.

Turning back to the determination made in step 410, if the process determines the round trip time is not greater than the current maximum round trip time, the process returns to step 404 and continues as described above. Turning further back to the determination made in step 402, if the process determines an end event has been received, the process returns to step 400 to send packets to endpoints as fast as possible.

Turning now to FIG. 5, a flowchart of a process for determining a minimum round trip time is depicted in accordance with an illustrative embodiment. The process illustrated in FIG. 5 may be implemented in a transport layer, such as transport layer 304 in FIG. 3.

The process begins by sending two packets on a connection to an endpoint (step 500). The process then waits for acknowledgements (step 502) and identifies round trip times (step 504). Next, a determination is made as to whether the round trip times are less than the current minimum round trip times (step 506). If the round trip times are less than the current minimum round trip times, the process sets the round trip time as the current minimum round trip time (step 508).

Then, a determination is made as to whether an end event was received (step 510). If an end event has been received, the process terminates. If an end event has not been received in step 510, the process returns to step 500 to send packets as described above. Similarly, turning back to the determination made on step 506, if the round trip time is not less than the current minimum round trip time, the process returns to step 500.

For adaptive distributions, both the maximum and minimum round trip times are needed. Both these calculations are performed independently of each other. In these examples, the minimum round trip time is calculated first. With the identification of maximum and minimum round trip times, the sending of data over a connection may be adjusted to maximize data transmission using known mechanisms for managing data transfer. For example, TCP buffer sizes and window sizes may be adjusted based on the round trip times to increase data transfer rates.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for identifying a maximum round trip time over a socket for use in transmitting data over a connection, the computer implemented method comprising:
during a beginning of a send operation through a socket, sending packets as fast as possible on the connection to an endpoint;
halting sending of the packets in response to an event;
identifying round trip times for the packets, which were sent; and
identifying the maximum round trip time from the round trip times, wherein the maximum round trip time used in sending the data to the endpoint.

2. The computer implemented method of claim 1, wherein the event is selected from one of an elapse of a selected time period, receipt of a signal that additional data cannot be written to the socket.

3. The computer implemented method of claim 1, wherein the computer implemented method is implemented in a transport layer.

4. The computer implemented method of claim 1 further comprising:
sending the data to the endpoint using the maximum round trip time.

5. The computer implemented method of claim 1, wherein the step of identifying round trip times for the packets which were sent comprises:
waiting for an acknowledgement a sent packet;
identifying a round trip time when the acknowledgment is received for the sent packet; and
repeating the waiting and identifying steps until all acknowledgements for sent packets are received.

6. The computer implemented method of claim 1, wherein the endpoint is a computer.

7. The computer implemented method of claim 1, wherein the event is one of a specified time period, a presence of stable round trip time measurements, a specified number of packets has been sent, or a specified amount of data has been sent.

8. A computer program product comprising:
a computer usable medium having computer usable program code for identifying a maximum round trip time over a socket for use in transmitting data over a connection, the computer program medium comprising:
computer usable program code, during a beginning of a send operation through a socket, sending packets as fast as possible on the connection to an endpoint;
computer usable program code for halting sending of the packets in response to an event;
computer usable program code for identifying round trip times for the packets, which were sent; and
computer usable program code for identifying the maximum round trip time from the round trip times, wherein the maximum round trip time used in sending the data to the endpoint.

9. The computer program product of claim 8, wherein the event is selected from one of an elapse of a selected time period, receipt of a signal that additional data cannot be written to the socket.

10. The computer program product of claim 8, wherein the computer program product is for a transport layer.

11. The computer program product of claim 8 further comprising:
computer usable program code for sending the data to the endpoint using the maximum round trip time.

12. The computer program product of claim 8, wherein the step of identifying round trip times for the packets which were sent comprises:
computer usable program code for waiting for an acknowledgement a sent packet;
computer usable program code for identifying a round trip time when the acknowledgment is received for the sent packet; and
computer usable program code for repeating the waiting and identifying steps until all acknowledgements for sent packets are received.

13. The computer program product of claim 8, wherein the endpoint is a computer.

14. The computer program product of claim 8, wherein the event is one of a specified time period, a presence of stable round trip time measurements, a specified number of packets has been sent, or a specified amount of data has been sent.

15. A data processing system comprising:
a bus;
a communications unit connected to the bus;
a storage device connected to the bus, wherein the storage device includes computer usable program code; and
a processor unit connected to the bus, wherein the processor unit executes the computer usable program code to identify a maximum round trip time over a socket for use in transmitting data over a connection; during a beginning of a send operation through a socket, send packets as fast as possible on the connection to an endpoint; halt sending of the packets in response to an event; identify round trip times for the packets, which were sent; and identify the maximum round trip time from the round trip times, wherein the maximum round trip time used in sending the data to the endpoint.

16. The data processing system of claim 15, wherein the event is selected from one of an elapse of a selected time period, receipt of a signal that additional data cannot be written to the socket.

17. The data processing system of claim 15, wherein the processor unit further executes the computer usable program code to send the data to the endpoint using the maximum round trip time.

18. The data processing system of claim 15, wherein in executing the computer usable program code to identify round trip times for the packets which were sent comprises:
the processor executes the computer usable program code to wait for an acknowledgement a sent packet; identify a round trip time when the acknowledgment is received for the sent packet; and repeat the waiting and identifying steps until all acknowledgements for sent packets are received.

19. The data processing system of claim 15, wherein the endpoint is a computer.

20. The data processing system of claim 15, wherein the event is one of a specified time period, a presence of stable round trip time measurements, a specified number of packets has been sent, or a specified amount of data has been sent.
